(19) United States
(12) Patent Application Publication
(10) Pub. No.: US 2014/0229722 A1
(43) Pub. Date: Aug. 14, 2014

(54) SYSTEMS AND METHODS FOR CALIBRATING THE ELEMENTS OF A QUANTUM PROCESSOR

(71) Applicant: D-Wave Systems Inc., Burnaby (CA)

(72) Inventor: Richard G. Harris, North Vancouver (CA)

(73) Assignee: D-Wave Systems Inc., Burnaby (CA)

(21) Appl. No.: 14/175,722

(22) Filed: Feb. 7, 2014

Related U.S. Application Data
(60) Provisional application No. 61/762,704, filed on Feb. 8, 2013.

(51) Int. Cl. G06F 9/445

(52) U.S. Cl. CPC G06F 9/44505
USPC 713/1

(57) ABSTRACT

Systems and methods for improving calibration procedures in a quantum processor architecture are described. For example, a dedicated calibration signal source is built into the architecture of the quantum processor for use during calibration. A single calibration signal source is communicatively coupled to many devices in the quantum processor architecture to provide an absolute calibration signal against which various parameters, responses, and/or behaviors of the many devices may be calibrated, either in series or in parallel. The use of a calibration signal source may reduce the time required to calibrate the elements of a quantum processor and/or improve the accuracy/precision of such calibrations.

### BACKGROUND

### Field

The present systems and methods generally relate to quantum processors and particularly relate to programming and calibrating quantum processor components.

### Quantum Processor Architecture

A quantum processor is any computer processor that is designed to leverage at least one quantum mechanical phenomenon (such as superposition, entanglement, tunneling, etc.) in the processing of quantum information. Many different designs for quantum processor hardware exist, including but not limited to: photonic quantum processors, superconducting quantum processors, nuclear magnetic resonance quantum processors, ion-trap quantum processors, topological quantum processors, quantum dot quantum processors, etc. Regardless of the specific hardware implementation, all quantum processors encode and manipulate quantum information in quantum mechanical objects or devices called quantum bits, or “qubits;” all quantum processors employ structures or devices for communicating information between qubits; and all quantum processors employ structures or devices for reading out a state of at least one qubit. The physical form of the qubits depends on the hardware employed in the quantum processors; e.g., photonic quantum processors employ photon-based qubits, superconducting quantum processors employ superconducting qubits, and so on.

Quantum processors may be architected to operate in a variety of different ways. For example, a quantum processor may be architected as a general-purpose processor or as a special-purpose processor, and/or may be designed to perform gate/circuit-based algorithms or adiabatic/annealing-based algorithms. Exemplary systems and methods for quantum processors are described in, for example: U.S. Pat. No. 7,135,701, U.S. Pat. No. 7,418,283, U.S. Pat. No. 7,533,068, U.S. Pat. 7,619,437, U.S. Pat. No. 7,639,035, U.S. Pat. No. 7,898,282, U.S. Pat. No. 8,008,942, U.S. Pat. No. 8,190,548, U.S. Pat. No. 8,195,596, U.S. Pat. No. 8,283,943, and US Patent Application Publication 2011-0022820, each of which is incorporated herein by reference in its entirety.

A quantum processor may include a large number (e.g., hundreds, thousands, millions, etc.) of programmable elements, including but not limited to: qubits, couplers, readout devices, latching devices (e.g., quantum flux parametron latching circuits), shift registers, digital-to-analog converters, and/or demultiplexer trees, as well as programmable sub-components of these elements such as programmable sub-components for correcting device asymmetries (e.g., inductance tuners, capacitance tuners, etc.), programmable sub-components for compensating unwanted signal drift, and so on. Examples of systems and methods for the programmable elements listed above are described in, for example: U.S. Pat. No. 7,876,248, U.S. Pat. No. 8,035,540, U.S. Pat. No. 8,098,179, U.S. Pat. No. 7,843,209, U.S. Pat. No. 8,018,244, U.S. Pat. No. 8,169,231, US Patent Application Publication 2011-0060780, US Patent Application Publication 2011-0057169, and US Patent Application Publication 2011-0065586, each of which is incorporated herein by reference in its entirety.

Among the large number of programmable elements of a quantum processor, there are inevitably; a) discrepancies between theoretical design specifications and the actual physical parameters of real, manufactured devices; and/or b) incongruencies between nominally identical devices. For this reason, a quantum processor typically requires at least some calibration before operation. Some exemplary systems and methods for calibrating the elements of a quantum processor are described in US Patent Application Publication 2011-0060780. Calibrating the elements of a quantum processor may involve, for example, applying signals to the processor elements; measuring responses, behaviors, and/or parameters that depend on the applied signals; and using the results of the measurements to influence how signals are applied to the processor during subsequent operation. For example, a processor element may be theoretically designed to produce a specific response when programmed with a signal of magnitude X, but due to a discrepancy between the theoretical design specifications and the actual physical parameters of the real, manufactured device, the processor element may be found to produce the specific response when programmed with a signal of magnitude (X+dx). Similarly, two programmable elements in a quantum processor may be theoretically designed to behave in the same way in response to a globally applied signal, but due to an incongruency in the fabrication of the two elements their behaviors may diverge. Calibrating the elements of a quantum processor may detect such incongruencies and inform their correction by, for example, the application of element-specific static bias signals. The calibration of the elements of a quantum processor is a challenging and time-consuming task that can involve the collection and analysis of very large amounts of data. In principle, each individual programmable element and potentially the pair-wise interactions between programmable elements may need to be characterized. Accordingly, the art of quantum computing will benefit from systems and methods for improving the calibration procedures for quantum processors.

### BRIEF SUMMARY

A quantum processor may be summarized as including a plurality of devices, wherein at least a first device in the plurality of devices has a determinable parameter, and wherein the plurality of devices includes a plurality of qubits; a calibration signal source that is communicatively coupleable to at least the first device in the plurality of devices, wherein the calibration signal source provides a calibration signal; and a readout system that is communicatively coupleable to at least the first device in the plurality of devices, wherein the readout system reads out a signal that is dependent on both the calibration signal and the determinable parameter of the first device to determine a value for the determinable parameter of the first device. The calibration signal source may be directly communicatively coupleable to the first device. The plurality of devices may include a second device, the second device communicatively coupleable to the first device, and the calibration signal source may be directly communicatively coupleable to the second device and indirectly communicatively coupleable to the first device via the second device such that the second device mediates communicative coupling between the calibration signal source and the first device. The plurality of devices may include at least a third device, the at least a third device communicatively coupleable to both the second device and the first device, and the calibration signal source may be indirectly communicatively coupleable to the first device via the second device and the at least a third device such that the second device and the at least a third device mediate communicative coupling between the calibration signal source and the first device.

The readout system may be directly communicatively coupleable to the first device. The plurality of devices may include a second device, the second device communicatively coupleable to the first device, and the readout system may be directly communicatively coupleable to the second device and indirectly communicatively coupleable to the first device via the second device such that the second device mediates communicative coupling between the readout system and the first device. The plurality of devices may include at least a third device, the at least a third device communicatively coupleable to both the second device and the first device, and the readout system may be indirectly communicatively coupleable to the first device via the second device and the at least a third device such that the second device and the at least a third device mediate communicative coupling between the readout system and the first device.

The quantum processor may include a superconducting quantum processor, the plurality of devices may include a plurality of superconducting devices, the first device may be a first superconducting device, the plurality of qubits may include a plurality of superconducting qubits, and the calibration signal source may include a superconducting calibration line formed by a superconducting current path. The superconducting calibration line may be galvanically coupled to at least one superconducting device in the plurality of superconducting devices. The superconducting calibration line may be inductively coupled to at least one superconducting device in the plurality of superconducting devices. The determinable parameter may include a persistent current of the first superconducting device. The plurality of superconducting devices may include at least a second superconducting device that is inductively coupleable to the first superconducting device, and the determinable parameter of the first superconducting device may include a mutual inductance between the first superconducting device and the second superconducting device. The second superconducting device may be a superconducting qubit.

The plurality of devices may include at least a second device having a determinable parameter, the calibration signal source may be communicatively coupleable to the at least a second device, and the readout system may be communicatively coupleable to the at least a second device, where the readout system reads out a signal that is dependent on both the calibration signal and the determinable parameter of the at least a second device to determine a value for the determinable parameter of the at least a second device. The calibration signal source may be communicatively coupleable to every device in the plurality of devices. The first device may be a qubit. The plurality of devices may include at least one of: a qubit, a latching device, a coupling device, a readout device, and a programming device; and the first device may be selected from the group consisting of: a qubit, a latching device, a coupling device, a readout device, and a programming device.

A method of calibrating at least one device in a quantum processor, where the quantum processor includes a plurality of devices including at least a first device having at least a first determinable parameter, a calibration signal source that is communicatively coupleable to the at least a first device, and a readout system that is communicatively coupleable to the at least a first device, may be summarized as including applying a calibration signal to the quantum processor via the calibration signal source; communicatively coupling at least a portion of the calibration signal from the calibration signal source to the first device; reading out a signal that is dependent on both the calibration signal and the first determinable parameter of the first device via the readout system; and determining a value for the first determinable parameter of the first device based at least in part on the signal that is read out via the readout system. The calibration signal source may be directly communicatively coupleable to the first device such that communicatively coupling at least a portion of the calibration signal from the calibration signal source to the first device may include communicatively coupling at least a portion of the calibration signal directly from the calibration signal source to the first device. The quantum processor may include at least a second device, the at least a second device communicatively coupleable to the first device, and communicatively coupling at least a portion of the calibration signal from the calibration signal source to the first device may include communicatively coupling at least a portion of the calibration signal from the calibration signal source to the at least a second device and communicatively coupling at least a portion of the calibration signal from the at least a second device to the first device such that the at least a second device mediates communicative coupling between the calibration signal source and the first device. The readout system may be directly communicatively coupleable to the first device such that reading out a signal that is dependent on both the calibration signal and the first determinable parameter of the first device via the readout system may include reading out at least a portion of the signal directly from the first device via the readout system.

The quantum processor may include at least a second device, the at least a second device communicatively coupleable to the first device, and reading out a signal that is dependent on both the calibration signal and the first determinable parameter of the first device via the readout system may include communicatively coupling at least a portion of the signal from the first device to the at least a second device and reading out at least a portion of the signal from the at least a second device via the readout system such that the at least a second device mediates communicative coupling between the first device and the readout system.

The quantum processor may include a superconducting quantum processor, the first device may include a first superconducting device, the calibration signal source may include a superconducting calibration line formed by a superconducting current path, the quantum processor may include at least a second superconducting device, and the first determinable parameter of the first device may include a mutual inductance between the first superconducting device and the second superconducting device. Applying a calibration signal of a known value to the quantum processor via the calibration signal source may include applying a calibration signal of a known value to the superconducting quantum processor via the superconducting calibration line. Communicatively coupling at least a portion of the calibration signal from the calibration signal source to the first device may include communicatively coupling at least a portion of the calibration signal from the superconducting calibration line to the first superconducting device. Reading out a signal that is dependent on both the calibration signal and the first determinable parameter of the first device via the readout system may include reading out a signal that is dependent on both the calibration signal and the mutual inductance between the first superconducting device and the second superconducting device via the readout system. Determining a value for the first determinable parameter of the first device based at least in part on the signal that is read out via the readout system may include determining a value for the mutual inductance between the first superconducting device and the second superconducting device based at least in part on the signal that is read out via the readout system. At least one of the first superconducting device and the second superconducting device may be a superconducting qubit.

The quantum processor may include a superconducting quantum processor, the first device may include a first superconducting device, the calibration signal source may include a superconducting calibration line formed by a superconducting current path, and the first determinable parameter of the first device may include a persistent current of the first superconducting device. Determining a value for the first determinable parameter of the first device based at least in part on the signal that is read out via the readout system may include determining a value for the persistent current of the first superconducting device based at least in part on the signal that is read out via the readout system.

The quantum processor may include at least a second device having a first determinable parameter, the calibration signal source may be communicatively coupleable to the at least a second device, and the readout system may be communicatively coupleable to the at least a second device. The method may then further include communicatively coupling at least a portion of the calibration signal from the calibration signal source to the at least a second device; reading out a signal that is dependent on both the calibration signal and the first determinable parameter of the at least a second device via the readout system; and determining a value for the first determinable parameter of the at least a second device based at least in part on the signal that is dependent on both the calibration signal and the first determinable parameter of the at least a second device that is read out via the readout system.

Each device in the plurality of devices may have at least one respective determinable parameter, the calibration signal source may be communicatively coupleable to each device in the plurality of devices, and the readout system may be communicatively coupleable to each device in the plurality of devices. The method may then further include communicatively coupling at least a portion of the calibration signal from the calibration signal source to each device in the plurality of devices; reading out a respective signal from each device in the plurality of devices via the readout system, wherein each respective signal is dependent on both the calibration signal and the respective determinable parameter of the respective device from which the signal is read out; and determining a respective value for the respective determinable parameter of each respective device based at least in part on each respective signal that is read out via the readout system.

The at least a first device may have a second determinable parameter, and the method may further include determining a value for the second determinable parameter of the at least a first device based at least in part on the value for the first determinable parameter of the at least a first device.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a portion of an exemplary superconducting quantum processor designed for AQC (and/or quantum annealing) that may be adapted for use in accordance with the present systems and methods.

FIG. 2 is a schematic diagram of a portion of a quantum processor including a superconducting flux qubit that is coupled to a DC-SQUID magnetometer (readout device) through an intermediate latching device.

FIG. 3 is a schematic diagram of a portion of a quantum processor including a superconducting flux qubit and a dedicated calibration signal source in accordance with the present systems and methods.

FIG. 4 is a schematic diagram of a portion of a quantum processor including two superconducting flux qubits and a single dedicated calibration signal source in accordance with the present systems and methods.

FIG. 5 is a flow-diagram showing a method of using a calibration signal source to facilitate that calibration of an element of a quantum processor in accordance with the present systems and methods.

FIG. 6 is a flow-diagram showing a method of using a calibration signal source to facilitate that calibration of the elements of a quantum processor in accordance with the present systems and methods.

FIG. 7 is a flow-diagram showing a method of using a calibration signal source to facilitate that calibration of each of a plurality of devices in a quantum processor in accordance with the present systems and methods.

### DETAILED DESCRIPTION

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures associated with quantum processors, such as quantum devices, coupling devices, and control systems including microprocessors, drive circuitry and nontransitory computer- or processor-readable media such as nonvolatile memory for instance read only memory (ROM), electronically eraseable programmable ROM (EEPROM) or FLASH memory, etc., or volatile memory for instance static or dynamic random access memory (ROM) have not been shown or described in detail to avoid unnecessarily obscuring descriptions of the embodiments of the present systems and methods. Throughout this specification and the appended claims, the words “element” and “elements” are used to encompass, but are not limited to, all such structures, systems and devices associated with quantum processors, as well as their related programmable parameters.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” or “an embodiment,” or “another embodiment” means that a particular referent feature, structure, or characteristic described in connection with the embodiment is included in at least one embodiment. Thus, the appearances of the phrases “in one embodiment,” or “in an embodiment,” or “another embodiment” in various places throughout this specification are not necessarily all referring to the same embodiment. Furthermore, the particular features, structures, or characteristics may be combined in any suitable manner in one or more embodiments.

It should be noted that, as used in this specification and the appended claims, the singular forms “a,” “an,” and “the” include plural referents unless the content clearly dictates otherwise. Thus, for example, reference to a problem-solving system including “a quantum processor” includes a single quantum processor, or two or more quantum processors, including a grid or distributed network of multiple quantum processors. It should also be noted that the term “or” is generally employed in its sense including “and/or” unless the content clearly dictates otherwise.

The headings provided herein are for convenience only and do not interpret the scope or meaning of the embodiments.

The various embodiments described herein provide systems and methods for calibrating the elements of a quantum processor. More specifically, the various embodiments described herein provide systems and methods for improving the calibration of a quantum processor by introducing dedicated calibration structures that may improve calibration accuracy and/or reduce total calibration time.

As an illustrative example, a superconducting quantum processor designed to perform adiabatic quantum computation and/or quantum annealing is used in the description that follows. However, as previously described, a person of skill in the art will appreciate that the present systems and methods may be applied to any form of quantum processor hardware (e.g., superconducting, photonic, ion-trap, quantum dot, topological, etc.) implementing any form of quantum algorithm(s) (e.g., adiabatic quantum computation, quantum annealing, gate/circuit-based quantum computing, etc.).

A typical adiabatic evolution may be represented by equation 1:

Hₑ=(1−s)H_{In}+sH_{f} (1)

where H_{In} is the initial Hamiltonian, H_{f} is the final or “problem” Hamiltonian, Hₑ is the evolution or instantaneous Hamiltonian, and s is the evolution coefficient which controls the rate of evolution. In general, s may vary from 0 to 1 with time t as s(t). A common approach to adiabatic quantum computation (“AQC”), described, for example, in Amin, M. H. S., “Effect of local minima on quantum adiabatic optimization”, PRL 100, 130503 (2008), is to start with an initial Hamiltonian of the form shown in equation 2:

$${H}_{In} = - \frac{1}{2} {\sum }_{i = 1}^{N} {Δ}_{i} {σ}_{i}^{x} \qquad ( 2 )$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms. An initial Hamiltonian of this form may, for example, be evolved to a final Hamiltonian of the form:

$${H}_{f} = - \frac{ɛ}{2} [ {\sum }_{i = 1}^{N} {h}_{i} {σ}_{i}^{z} + {\sum }_{i , j = 1}^{N} {J}_{ij} {σ}_{i}^{z} {σ}_{j}^{z} ] \qquad ( 3 )$$

where N represents the number of qubits, σᵢ^{z} is the Pauli z-matrix for the i^{th} qubit, hᵢ and J_{i,j} are dimensionless local fields coupled into each qubit, and E is some characteristic energy scale for H_{f}. Here, the σᵢ^{z} and σᵢ^{z}σⱼ^{z} terms are examples of “diagonal” terms. Throughout this specification, the terms “final Hamiltonian” and “problem Hamiltonian” are used interchangeably. Hamiltonians such as H_{In} and H_{f} in equations 2 and 3, respectively, may be physically realized in a variety of different ways. A particular example is realized by an implementation of superconducting qubits.

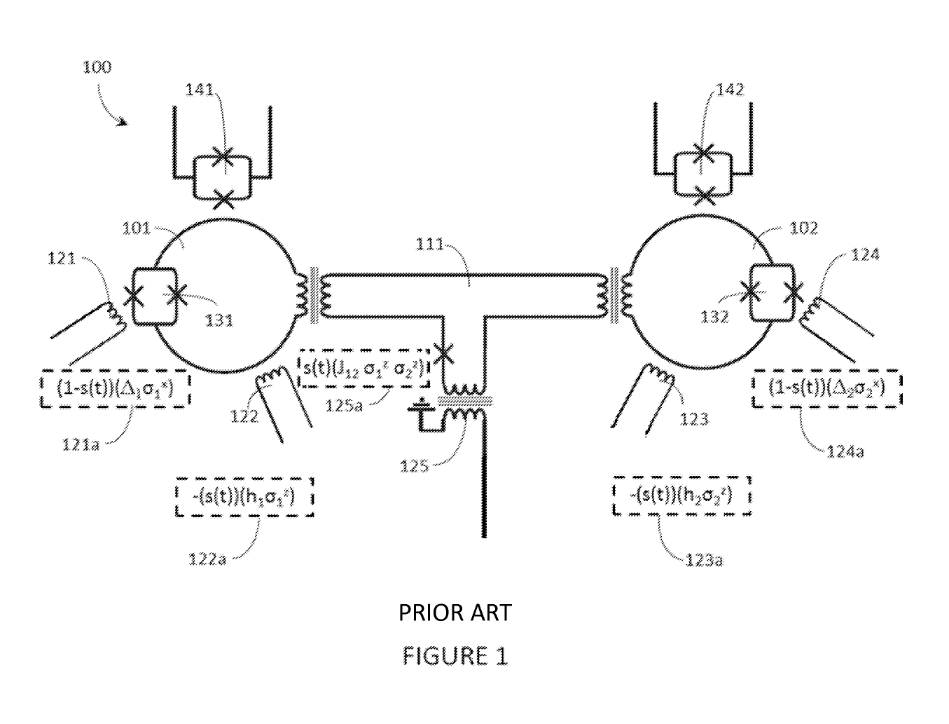

FIG. 1 is a schematic diagram of a portion of an exemplary superconducting quantum processor 100 designed for AQC (and/or quantum annealing) that may be adapted for use in accordance with the present systems and methods. The portion of superconducting quantum processor 100 shown in FIG. 1 includes two superconducting qubits 101, 102 and a tunable ZZ-coupler 111 coupling information therebetween (i.e., providing pair-wise coupling between qubits 101 and 102). While the portion of quantum processor 100 shown in FIG. 1 includes only two qubits 101, 102 and one coupler 111, those of skill in the art will appreciate that quantum processor 100 may include any number of qubits and any number of coupling devices coupling information therebetween.

The portion of quantum processor 100 shown in FIG. 1 may be implemented to physically realize AQC and/or QA by initializing the system with the Hamiltonian described by equation 2 and evolving the system to the Hamiltonian described by equation 3 in accordance with the evolution described by equation 1. Quantum processor 100 includes a plurality of interfaces 121-125 that are used to configure and control the state of quantum processor 100. Each of interfaces 121-125 may be realized by a respective inductive coupling structure, as illustrated, as part of a programming subsystem and/or an evolution subsystem. Such a programming subsystem and/or evolution subsystem may be separate from quantum processor 100, or it may be included locally (i.e., on-chip with quantum processor 100) as described in, for example, U.S. Pat. No. 7,876,248 and U.S. Pat. No. 8,035,540.

In the operation of quantum processor 100, interfaces 121 and 124 may each be used to couple a flux signal into a respective compound Josephson junction 131,132 of qubits 101 and 102, thereby realizing the Δᵢ terms in the system Hamiltonian. This coupling provides the off-diagonal σ^{x} terms of the Hamiltonian described by equation 2 and these flux signals are examples of “disordering signals.” Similarly, interfaces 122 and 123 may each be used to couple a flux signal into a respective qubit loop of qubits 101 and 102, thereby realizing the hᵢ terms in the system Hamiltonian. This coupling provides the diagonal σ^{z} terms of equation 3. Furthermore, interface 125 may be used to couple a flux signal into coupler 111, thereby realizing the Jᵢⱼ term(s) in the system Hamiltonian. This coupling provides the diagonal σ^{z}ᵢσ^{z}ⱼ terms of equation 3. In FIG. 1, the contribution of each of interfaces 121-125 to the system Hamiltonian is indicated in boxes 121a-125a, respectively. Thus, throughout this specification and the appended claims, the terms “problem formulation” and “configuration of a number of programmable parameters” are used to refer to, for example, a specific assignment of hᵢ and Jᵢⱼ terms in the system Hamiltonian of a superconducting quantum processor via, for example, interfaces 121-125.

In the context of quantum processor 100, the term “programming subsystem” is used to generally describe the interfaces (e.g., “programming interfaces” 122, 123, and 125) used to apply the programmable parameters (e.g., the hᵢ and Jᵢⱼ terms) to the programmable elements of quantum processor 100 and other associated control circuitry and/or instructions. As previously described, the programming interfaces of the programming subsystem may communicate with other subsystems which may be separate from the quantum processor or may be included locally on the processor. Similarly, in the context of quantum processor 100, the term “evolution subsystem” is used to generally describe the interfaces (e.g., “evolution interfaces” 121 and 124) used to evolve the programmable elements of quantum processor 100 and other associated control circuitry and/or instructions. For example, the evolution subsystem may include annealing signal lines and their corresponding interfaces (121, 124) to the qubits (101, 102).

Quantum processor 100 also includes readout devices 141 and 142, where readout device 141 is configured to read out the state of qubit 101 and readout device 142 is configured to read out the state of qubit 102. In the embodiment shown in FIG. 1, each of readout devices 141 and 142 comprises a respective DC-SQUID that is configured to inductively couple to the corresponding qubit (qubits 101 and 102, respectively). In the context of quantum processor 100, the term “readout subsystem” is used to generally describe the readout devices 141, 142 used to read out the final states of the qubits (e.g., qubits 101 and 102) in the quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.). Qubit readout may also be performed using alternative circuits, such as that described in PCT Patent Application Publication 2012-064974.

While FIG. 1 illustrates only two physical qubits 101, 102, one coupler 111, and two readout devices 141, 142, a quantum processor (e.g., processor 100) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

At least some of the devices illustrated in FIG. 1 are simplified in order to enhance clarity. As an example, the structure of the qubits (101, 102) and the interface to the readout devices (141, 142) are simplified in FIG. 1 in order to reduce clutter. While the simplified circuits of quantum processor 100 may be sufficient for some applications, a quantum processor may employ qubit circuits and/or readout schemes that are considerably more complicated than those which are illustrated in FIG. 1.

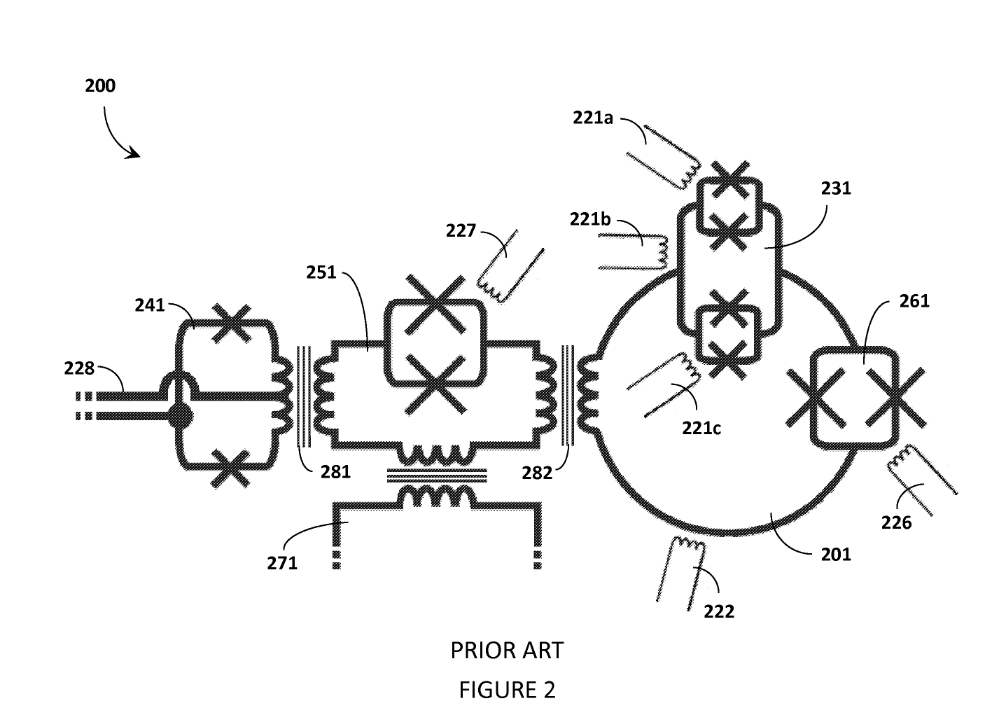

FIG. 2 is a schematic diagram of a portion of a quantum processor 200 including a superconducting flux qubit 201 that is coupled to a DC-SQUID magnetometer (readout device) 241 through an intermediate latching device 251. FIG. 2 may, for example, represent a more detailed schematic of qubit 101 and its interface with readout device 141 from FIG. 1. Qubit 201 includes a compound Josephson junction structure 231 that has been expanded into a “compound compound Josephson junction” in order to provide a mechanism for correcting Josephson junction asymmetry in accordance with the teachings of US Patent Application Publication 2011-0057169. As a result, programming interface 121 from FIG. 1 has been expanded into three programming interfaces 221a, 221b, 221c in order to control the signals applied to compound Josephson junction structure 231. Qubit 201 is coupled to programming interface 222 in order to realize the hᵢ terms in the system Hamiltonian as previously described, but qubit 201 also includes an inductance tuner 261 in order to provide a mechanism for tuning the inductance of qubit 201 in accordance with the teachings of US Patent Application Publication 2011-0057169. Inductance tuner 261 is controlled by coupling to an additional programming interface 226. Additional devices that may be included in or coupled to qubit 201 (such as, for example, coupling devices for communicating with other qubits such as coupling device 111 from FIG. 1 and/or a mechanism for compensating changes in qubit persistent current during annealing as taught in US Patent Application Publication 2011-0060780) are not shown in FIG. 2 in order to reduce clutter.

The state of qubit 201 is defined by the persistent current of qubit 201. The persistent current of qubit 201 is read out by coupling qubit 201 to DC-SQUID magnetometer 241 through latching device 251 as described in U.S. Pat. No. 8,169,231. Latching device 251 is illustrated as being inductively coupled to a shift register 271 in accordance with the teachings of U.S. Pat. No. 8,169,231. Latching device 251 is controlled by programming interface 227 and magnetometer 241 is controlled by programming interface 228. A qubit system that has been designed for experiments related to the characterization of qubit parameters and/or qubit behavior may include mechanisms for directly measuring other parameters of the system (e.g., the critical current of any/all Josephson junctions, the qubit inductance, etc.), but such mechanisms can add overwhelming complexity to, and ultimately inhibit the scalability of, a quantum processor designed to solve real computational problems. In a quantum processor such as processor 100 from FIG. 1, a single readout mechanism that is designed to readout the state of a qubit for the purpose of computation may be all that is available (such enhances the physical scalability of the processor architecture by, for example, reducing the number of elements in the processor, reducing the physical size and/or areal density of the processor, and/or limiting the number of programming channels required to interface with the processor). The majority of all other parameters of the qubits in the processor, as well as parameters governing the interactions between qubits and between qubits and other devices, may generally be inferred from measurements of the persistent currents in the qubits in response to signals applied through the various programming interfaces. For example, the majority of the parameters of qubit 201, as well as the parameters governing the interactions between qubit 201, latching device 231 and magnetometer 241, may generally be inferred from measurements of the persistent current in qubit 201 in response to signals applied through programming interfaces 221a, 221b, 221c, 222, 226, 227, and 228. However, the value of the persistent current of qubit 201 that is actually read out by magnetometer 241 depends on a number of intervening parameters, including the coupling between qubit 201 and latching device 251 (i.e., the mutual inductance between qubit 201 and latching device 251 for the inductive coupling illustrated, though a person of skill in the art will appreciate that other coupling schemes, such as galvanic coupling, may similarly be employed) and the coupling between latching device 251 and magnetometer 241 (i.e., the mutual inductance between latching device 251 and magnetometer 241). Part of the need to calibrate the elements of a quantum processor is due to the need to characterize such intervening parameters (e.g., mutual inductances between devices), and the various embodiments described herein provide systems and methods for improved calibration procedures.

An exemplary procedure for calibrating the persistent current of qubit 201 is now described. The purpose of this description is to highlight the number of intermediate calibration steps required in order to calibrate the persistent current of qubit 201 in a quantum processor architecture employing the circuits and devices of FIG. 2. This description is provided for illustrative purposes only. A person of skill in the art will appreciate that a similar situation may arise in other quantum processor architectures, such as alternative superconducting architectures, ion-trap architectures, photonic architectures, etc., as well as architectures designed to perform gate/circuit-based quantum algorithms.

The persistent current of qubit 201 may be calibrated using the circuits and devices of processor 200 in a series of acts or operations as follows:
1) The persistent current |Iᵣₒ^{p}| in DC-SQUID 241 is calibrated. An independently calibrated current is applied to DC-SQUID 241 via programming interface 228 and the switching current as a function of DC-SQUID flux bias is measured. A model is then used to estimate |Iᵣₒ^{p}| when the independently calibrated current is deactivated (in the presence of finite flux bias).
2) The mutual inductance 281 (M₂₈₁) between DC-SQUID 241 and latching device 251 is calibrated. A signal is applied from DC-SQUID 241 to latching device 251 through M₂₈₁. Provided the flux period of latching device 251 has been independently calibrated, the signal from DC-SQUID 241 is then nulled in latching device 251 by a signal Φ₂₂₇ applied via programming interface 227. M₂₈₁ may then be calculated as:

M₂₈₁=Φ₂₂₇/2|Iᵣₒ^{p}|
3) The persistent current |I_{qfp}^{p}| in latching device 251 is calibrated. A signal Φ₂₂₇ is applied to latching device 251 via programming interface 227 to latch the state of latching device 251. This latched state is read out via DC-SQUID 241 and is nulled by a signal Φ₂₂₈ applied through programming interface 228. |I_{qfp}^{p}| may then be calculated as:

|I_{qfp}^{p}|=Φ₂₂₈/2M₂₈₁
4) The mutual inductance 282 (M₂₈₂) between latching device 251 and qubit 201 is calibrated. A signal Φ₂₂₇ is again applied to latching device 251 via programming interface 227 to latch the state of latching device 251. This latched state (i.e., |I_{qfp}^{p}|) is then coupled to qubit 201 through M₂₈₂. Provided the period of qubit 201 has been independently calibrated, the signal from latching device 251 is then nulled in qubit 201 by a signal Φ₂₂₂ applied via programming interface 222. M₂₈₂ may then be calculated as:

M₂₈₂=Φ₂₂₂/2|I_{qfp}^{p}|
5) The persistent current |I_{qubit}^{p}| in qubit 201 is then calibrated. A signal is applied via programming interface 221b to raise the tunnel barrier and localize a persistent current state in qubit 201. This state is detected as a change in flux ΔΦ in latching device 251. Given that the period of latching device 251 has already been calibrated, |I_{qubit}^{p}| may then be calculated as:

|I_{qubit}^{p}|/ΔΦ2M₂₈₂

The calibration procedure outlined above may be deemed by some as somewhat complicated. The calibration of the persistent current |I_{qubit}^{p}| in qubit 201 using the circuits and devices of processor 200 depends on the calibration of the mutual inductance M₂₈₂ between qubit 201 and latching 251, which depends on the calibration of the persistent current |I_{qfp}^{p}| in latching device 251, which depends on the calibration of the mutual inductance M₂₈₁ between latching device 251 and DC-SQUID 241, which depends on the calibration of the persistent current |Iᵣₒ^{p}|in DC-SQUID 241. There are a large number of measurements that need to be made in the calibration procedure outlined above, resulting in a complicated set of dependencies between the calibrated parameters. Measurement errors (even small errors) are inevitable and an error in any one calibrated parameter may propagate through to other parameters (and the error may grow when propagated and/or when combined with other measurement errors). Furthermore, at least one of the parameters in the above calibration procedure (i.e., |Iᵣₒ^{p}|) relies on a model-dependent estimation which almost invariably introduces some divergence from reality. The procedure outlined above is time-consuming and resource intensive (requiring on the order of weeks to calibrate a processor with hundreds of qubits), and the precision/accuracy of the resulting calibrated parameters is limited by the large number of measurements and dependencies between parameters. Clearly, there is a need in the art for improved systems and methods for calibrating the elements of a quantum processor.

Throughout this specification and the appended claims, elements and/or parameters of a quantum processor that are measured and/or calibrated during a calibration procedure are referred to as “determinable parameters.” Exemplary determinable parameters from the exemplary calibration procedure outlined above include: qubit persistent current |I_{qubit}^{p}|, mutual inductances between devices such as M₂₈₁ and M₂₈₂, latching device persistent current |I_{qfp}^{p}|, and DC-SQUID persistent current |Iᵣₒ^{p}|. For greater certainty, throughout this specification and appended claims, the term “determinable parameter” is used to refer to any parameter of any device or component of a quantum processor for which the value may be determined via direct measurement and/or via calculation based on a measurement. A determinable parameter may include, for example, a parameter that is designed to have a particular value but, due to the imprecision of fabricating real, physical devices, needs to have its actual value determined during calibration in order to ensure proper operation of the quantum processor.

The various embodiments described herein provide improved systems and methods for calibrating the elements of a quantum processor. For example, the calibration procedure described above may be greatly simplified by introducing a dedicated calibration signal source in the quantum processor architecture. This simplification may reduce the number of measurements required to calibrate important parameters (such as qubit persistent current), resulting in a faster and/or more accurate calibration procedure. As an illustrative example, a dedicated calibration signal source may be realized by a superconducting signal line (i.e., a superconducting current path) in a superconducting quantum processor architecture as described in more detail below. However, a person of skill in the art will appreciate that a dedicated calibration signal source may similarly be implemented in any alternative type of quantum processor architecture (e.g., a photonic quantum processor, a quantum-dot quantum processor, etc.) using whatever form of communicative hardware is appropriate for that particular type of quantum processor.

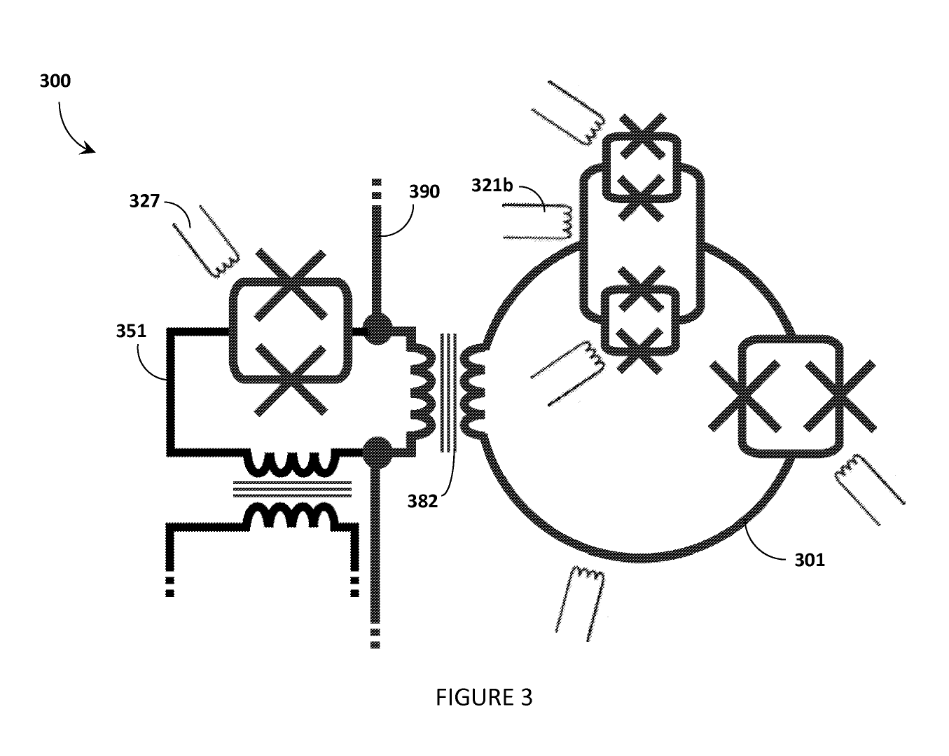

FIG. 3 is a schematic diagram of a portion of a quantum processor 300 including a superconducting flux qubit 301 and a dedicated calibration signal source 390 in accordance with the present systems and methods. Qubit 301 is inductively coupled to a latching device 351 similar to the coupling between qubit 201 and latching device 251 of processor 200 from FIG. 2. In superconducting processor 300, calibration signal source 390 is a superconducting signal line formed by a superconducting current path that is galvanically coupled to latching device 351. Calibration signal source 390 is coupled to signal generation and control electronics (not shown in FIG. 3) that may, for example, be external to quantum processor 300 and housed at room temperature. Calibration signal source 390 provides an independently calibrated current that may be used to calibrate the elements of quantum processor 300. The current through calibration signal source 390 may be substantially larger than the critical current of latching device 351 (as determined by the Josephson junctions in latching device 351) such that the vast majority of the independently calibrated current is routed through the mutual inductance M₃₈₂ between latching device 351 and qubit 301. Therefore, using calibration signal source 390, acts 1-3 of the previously-described exemplary calibration procedure for quantum processor 200 may be omitted and the mutual inductance M₃₈₂ between latching device 351 and qubit 301 may be calibrated directly from calibration signal source 390. This greatly reduces the number of measurements and dependencies (and associated errors and propagated errors) in, for example, the calibration of the persistent current in qubit 301 compared to the calibration of the persistent current in qubit 201. To illustrate this reduction, an exemplary procedure for calibrating the persistent current in qubit 301 of processor 300 is now described.

The persistent current of qubit 301 may be calibrated using the circuits and devices of processor 300 in a series of acts or operations as follows:
1) The mutual inductance 382 (M₃₈₂) between latching device 351 and qubit 301 is calibrated. An independently calibrated current is transmitted through superconducting current path 390. To ensure that the vast majority of this current flows through mutual inductance M₃₈₂, programming interface 327 may be used to bias the compound Josephson junction of latching device 351 with a signal of about ½Φ₀. The flux period P of qubit 301 is then measured using the current in superconducting current path 390 as the applied bias. M₃₈₂ may then be calculated as:

M₃₈₂=Φ₀/P
2) The persistent current |I_{qubit}^{p}| in qubit 301 is then calibrated. A signal is applied via programming interface 321b to raise the tunnel barrier and localize a persistent current state in qubit 301. This state is detected as a change in flux ΔΦ in latching device 351. Provided that the period of latching device 351 has already been calibrated,|I_{qubit}^{p}| may then be calculated as:

|I_{qubit}^{p}|=ΔΦ2M₃₈₂

Clearly, the procedure for calibrating the persistent current of qubit 301 in processor 300 using calibration signal source 390 is much simpler than the procedure for calibrating the persistent current of qubit 201 in processor 200 without a dedicated calibration signal source. The calibration procedure described for processor 300 comprises fewer measurements, fewer calculation acts, and fewer (e.g., no) model-dependent estimations compared to the calibration procedure described for processor 200. The result is that the addition of calibration signal source 390 in processor 300 enables faster and/or more accurate/precise calibration of processor elements.

The exemplary procedure for calibrating the persistent current of qubit 301 described above is provided for illustrative purposes only and is not intended to limit the present systems and methods to the calibration of qubit persistent currents. In accordance with the present systems and methods, a quantum processor may comprise a plurality of devices (i.e., any number of devices), wherein at least a first device in the plurality of devices includes a determinable parameter, and wherein the plurality of devices includes a plurality of qubits; a calibration signal source that is communicatively coupleable to at least the first device in the plurality of devices, wherein the calibration signal source provides a calibration signal of a known value; and a readout system that is communicatively coupleable to at least the first device in the plurality of devices, wherein the readout system reads out a signal that is dependent on both the calibration signal and the determinable parameter of the first device to determine a value for the determinable parameter of the first device. The calibration signal source may be used to determine a value for any determinable parameter within the quantum processor, including a first device that is directly communicatively coupleable to the calibration signal source and/or a first device that is indirectly communicatively coupleable to the calibration signal source (e.g., a first device for which communicative coupling with the calibration signal source is mediated by at least a second device). A further benefit of the present systems and methods is that a single calibration signal source may be used to communicatively couple a calibration signal (e.g., an independently calibrated current) to multiple devices (e.g., a first device, a second device, a third device, etc.) in a quantum processor architecture.

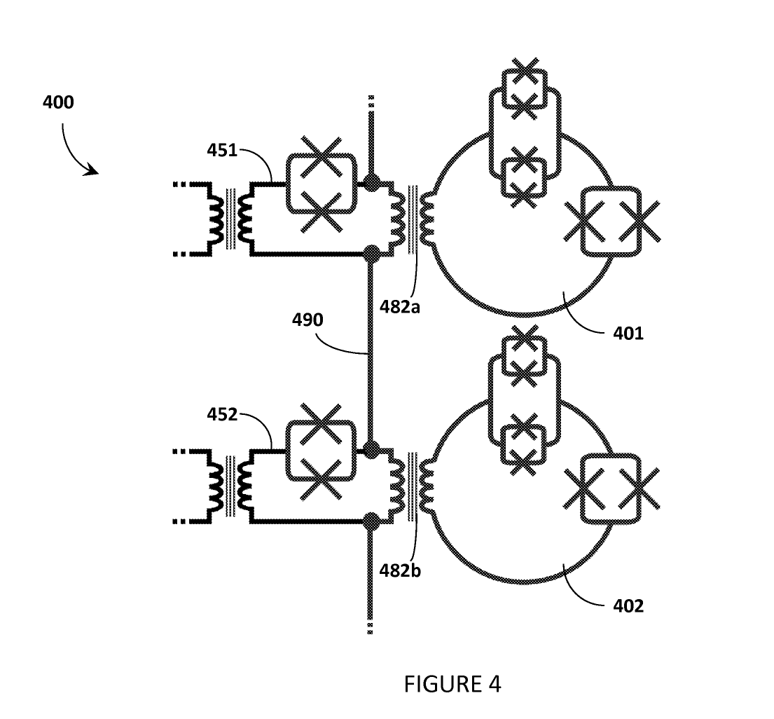

FIG. 4 is a schematic diagram of a portion of a quantum processor 400 including two superconducting flux qubits 401, 402 and a single dedicated calibration signal source 490 in accordance with the present systems and methods. Qubit 401 is inductively coupled to a latching device 451 and qubit 402 is inductively coupled to a latching device 452. Calibration signal source 490 is a superconducting calibration line formed by a superconducting current path. Superconducting current path 490 is galvanically coupled to both latching devices 451 and 452 in series such that when a current is transmitted through superconducting current path 490, substantially the same current is received by both mutual inductance M₄₈₂ₐ between latching device 451 and qubit 401 and mutual inductance M_{482b} between latching device 452 and qubit 402. In a typical architecture, quantum processor 300 may be designed so that M₄₈₂ₐ=M_{482b}, but in practice non-uniformities in the fabrication process may produce a situation in which M₄₈₂ₐ≠M_{482b}. At least part of the purpose of calibrating M₄₈₂ₐ and M_{482b} is to identify any such discrepancies so that they can be accommodated/compensated in the operation of quantum processor 400. M₄₈₂ₐ and M_{482b}, as well as the respective persistent current in each of qubits 401 and 402, may be calibrated using calibration signal source 490 in substantially the same way as that described previously for the elements of processor 300. Thus, the addition of a single dedicated calibration signal source 490 that is directly communicatively coupleable to various elements throughout the architecture of a quantum processor 400 provides an absolute calibration signal from which many (e.g., all) of the elements of the processor may be calibrated without relying on extensive sequences of intermediate calibration acts like in processor 200 from FIG. 2. Directly communicatively coupling calibration signal source 490 to multiple devices (as illustrated in processor 400) enables each device to be calibrated in a smaller number of acts or operations compared to the procedure outlined for processor 200 from FIG. 2. In accordance with the present systems and methods, a single calibration signal source may be used to communicatively couple to and/or calibrate any number of devices and/or elements of a quantum processor architecture.

In a superconducting quantum processor architecture in which the calibration signal source takes the form of a superconducting current path (e.g., calibration signal sources 390 and 490 from FIGS. 3 and 4, respectively), the inclusion of the calibration signal source adds at least one signal line to the processor. In general, it is preferable to limit the number of signal lines in a processor to simplify the input/output system and reduce the areal density of processor elements. However, the inclusion of a calibration signal source may enable a simplification of the read out system employed in the quantum processor and may therefore reduce the total number of signal lines employed. As an example, processor 200 in FIG. 2 (which does not employ a calibration signal source) includes both DC-SQUID 241 and shift register 271 for reading out the state of qubit 201 through latching device 251, whereas neither processor 300 from FIG. 3 (which includes calibration signal source 390) nor processor 400 from FIG. 4 (which includes calibration signal source 490) includes similar DC-SQUID structures. In some processor architectures (e.g., processors 100 and 200), the read out system may employ individual read out devices (e.g., 141, 142, and 241) for respectively measuring the states of individual qubits as described in, for example, U.S. Pat. No. 8,169,231. However, in some processor architectures (e.g., processors 300 and 400), the read out system may employ shift registers that copy qubit states and route the copied states to a single read out mechanism (or a small number of readout mechanisms) as described in, for example, U.S. Pat. No. 8,169,231 and PCT Patent Application Publication 2012-064974. A shift register-based read out system may be advantageous because it requires fewer signal lines to operate, and may be advantageous for use during computation because it may be faster to operate than qubit-specific read out devices, but a shift register-based read out system can be disadvantageous for use in some calibration procedures because it can increase the number of measurements, dependencies, errors, and propagated errors. A quantum processor that employs a shift register-based read out system for measuring the states of qubits during computation may still include individual, qubit-specific read out mechanisms for use during calibration of the processor elements. For example, quantum processor 200 from FIG. 2 includes a latching device 251 that is coupled to both a DC-SQUID 241 and a shift register circuit 271. In processor 200, shift register 271 may be used to read out the state of qubit 201 during computations but DC-SQUID 241 may be used to calibrate the persistent current of qubit 201 using the exemplary calibration procedure described. In other words, processor 200 has shift register 271 for use during computation, but also includes DC-SQUID 241 for use only during calibration. Once the elements of processor 200 have been calibrated, DC-SQUID 241 may no longer be used, but the footprint of DC-SQUID 241 remains on processor 200 (including the resulting increased areal density, potential cross-talks between circuit elements, dedicated signal lines, etc.) even when DC-SQUID 241 is not in use. In accordance with the present systems and methods, the inclusion of a dedicated calibration signal source enables non-qubit-specific read out mechanisms such as shift registers and the other schemes described in PCT Patent Application Publication 2012-064974 to be employed without the need to also include qubit-specific read out mechanisms for calibration purposes. Thus, even though the inclusion of a calibration signal source may add a signal line to the processor architecture, it may also allow qubit-specific read out mechanisms to be completely removed from the processor architecture and produce a net reduction in the total number of signal lines required. Removing qubit-specific read out mechanisms (e.g., DC-SQUID 241) can also free up considerable space in the processor architecture and simplify the layouts of processor elements.

In both processors 300 and 400, the calibration signal source (i.e., 390 and 490, respectively) is galvanically coupled to latching devices (i.e., latching device 351 and latching devices 451, 452, respectively) that are themselves inductively coupled to qubits (i.e., qubit 301 and qubits 401, 402, respectively). However, these coupling schemes are provided for illustrative purposes only and alternative processor architectures may employ alternative coupling schemes. For example, a calibration signal source may be inductively coupled to a device in a quantum processor as opposed to galvanically coupled and such would necessitate the calibration of the corresponding mutual inductance. Likewise, a calibration signal source may be communicatively coupled to any element or device of a quantum processor and need not be exclusively coupled to a latching device. In many architectures, it may be advantageous to galvanically couple a calibration signal source to a device in order to avoid having to calibrate the mutual inductance of an inductive coupling, and it may be advantageous to couple a calibration signal source to a device that is “close to” a qubit to minimize the number of measurements and dependencies when calibrating the qubit parameter(s). For example, it may be advantageous to couple a calibration signal source to a device that is itself directly communicatively coupleable to a qubit (as is the case for latching devices 351, 451, and 452) so that the qubit parameter(s) may be calibrated in few acts or operations. A calibration signal source may be coupled directly to a qubit, but in such a configuration the calibration signal source may undesirably serve as a source of noise into the qubit during computation. In many architectures, it may be advantageous to provide a buffer between the calibration signal source and a qubit by, for example, coupling the calibration signal source to a device that is itself directly coupled to the qubit as depicted in FIGS. 3 and 4.

As described in U.S. Pat. No. 8,169,231 and PCT Patent Application Publication 2012-064974, a latching device (e.g., latching devices 351, 451, and 452) may be galvanically coupled to a qubit in some architectures. With a latching device galvanically coupled to a qubit, a calibration signal source may still be coupled to the latching device but in such a configuration the calibration signal source may undesirably serve as a source of noise into the qubit during computation. However, when a latching device is galvanically coupled to a qubit, the latching device may also be inductively coupled to a shift register (e.g., as shown in FIGS. 2-4) and the calibration signal source may be coupled to the shift register so that it is still removed from the qubit by at least one inductive coupling.

The various embodiments described herein provide systems for facilitating calibration procedures in quantum processor hardware by introducing a dedicated calibration signal source or sources within the quantum processor architecture. The various embodiments described herein also provide methods for improved calibration procedures that employ these systems.

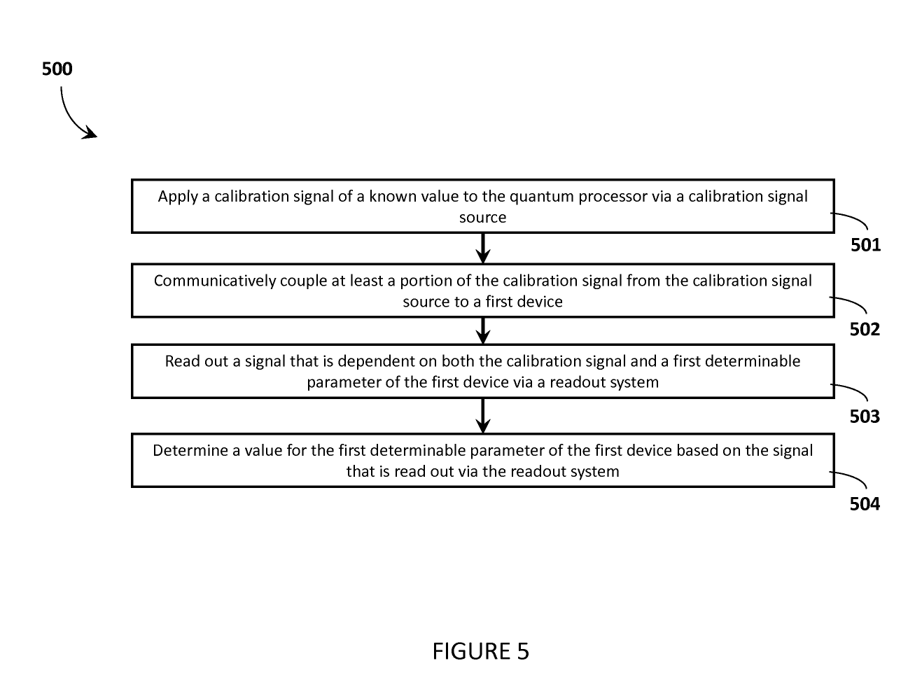

FIG. 5 is a flow-diagram showing a method 500 of using a calibration signal source to facilitate that calibration of an element of a quantum processor in accordance with the present systems and methods. Method 500 includes four acts 501, 502, 503, and 504, though those of skill in the art will appreciate that in alternative embodiments certain acts may be omitted and/or additional acts may be added. Those of skill in the art will appreciate that the illustrated order of the acts is shown for exemplary purposes only and may change in alterative embodiments.

At 501, a calibration signal of a known value is applied to the quantum processor (e.g., to at least one element of the quantum processor) via a calibration signal source. As illustrated in FIGS. 3 and 4, in a superconducting quantum processor architecture the calibration signal source may be, for example, a superconducting calibration line formed by a superconducting current path (e.g., 390 from FIGS. 3 and 490 from FIG. 4). At 502, at least a portion of the calibration signal is communicatively coupled from the calibration signal source to a first device (e.g., to a first element of the quantum processor). The first device may be a qubit, a device that is coupled to a qubit such as a latching device or coupling device, or any other device in the quantum processor architecture. The calibration signal source may be directly communicatively coupleable to the first device or the calibration signal source may be indirectly communicatively coupleable to the first device. If the calibration signal source is indirectly communicatively coupleable to the first device, then the calibration signal source may be directly communicatively coupleable to a second device that is communicatively coupleable to the first device such that the second device mediates communicative coupling between the calibration signal source and the first device.

At 503, a signal that is dependent on both the calibration signal and a first determinable parameter of the first device is read out via a readout system. As previously described, in a superconducting quantum processor the first determinable parameter may include a mutual inductance or a persistent current. The readout system may be directly communicatively coupleable to the first device or the readout system may be indirectly communicatively coupleable to the first device. If the readout system is indirectly communicatively coupleable to the first device, then the readout system may be directly communicatively coupleable to a second device that is communicatively coupleable to the first device such that the second device mediates communicative coupling between the readout system and the first device.

At 504, a value for the first determinable parameter of the first device is determined based on the signal that is read out via the readout system. The value for the first determinable may be the value of the signal that is read out via the readout system or it may be a value that is calculated, estimated, or inferred from the value of the signal that is read out via the readout system. In some cases, the first device may include a second determinable parameter and method 500 may be extended to include determining a value for the second determinable parameter of the first device based at least in part on the value for the first determinable parameter of the first device. For example, in the context of processor 300 from FIG. 3, the first device may be qubit 301, the first determinable parameter of the first device may be the mutual inductance M₃₈₂ between qubit 301 and latching device 351, and the second determinable parameter of qubit 301 may be the persistent current |I_{qubit}^{p}| in qubit 301. In this example, communicatively coupling at least a portion of the calibration signal from the calibration signal source to the first device in accordance with act 502 includes indirectly communicatively coupling a least a portion of the calibration signal from superconducting current path 390 to qubit 301 via the mutual inductance M₃₈₂ between qubit 301 and latching device 351.

As previously described in the context of FIG. 4, a single calibration signal source may be communicatively coupled to multiple (i.e., at least two) devices in a quantum processor for the purpose of calibrating determinable parameters of the multiple devices.

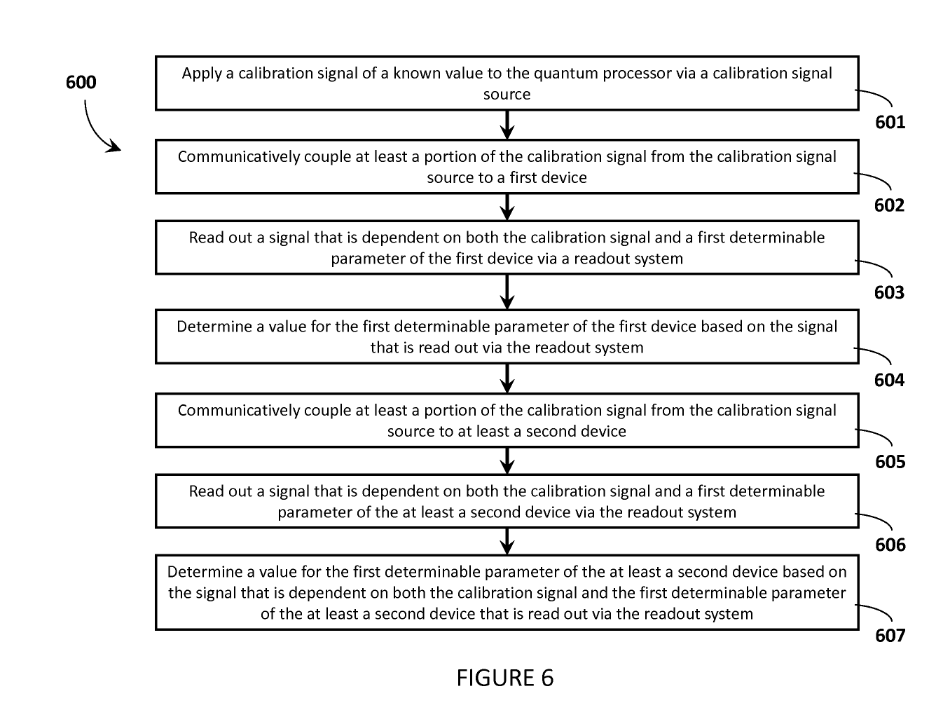

FIG. 6 is a flow-diagram showing a method 600 of using a calibration signal source to facilitate that calibration of the elements of a quantum processor in accordance with the present systems and methods. Method 600 includes seven acts 601, 602, 603, 604, 605, 606, and 607, though those of skill in the art will appreciate that in alternative embodiments certain acts may be omitted and/or additional acts may be added. Those of skill in the art will appreciate that the illustrated order of the acts is shown for exemplary purposes only and may change in alterative embodiments. Acts 601-604 are essentially the same as acts 501-504 of method 500 from FIG. 5.

In brief: at 601, a calibration signal of a known value is applied to the quantum processor (e.g., to at least one element of the quantum processor) via a calibration signal source; at 602, at least a portion of the calibration signal is communicatively coupled from the calibration signal source to a first device (e.g., to a first element of the quantum processor); at 603, a signal that is dependent on both the calibration signal and a first determinable parameter of the first device is read out via a readout system; and at 604, a value for the first determinable parameter of the first device is determined based on the signal that is read out via the readout system. Method 600 continues with acts 605-607 which describe using the same calibration signal source to determine a value for a determinable parameter of a second device in the quantum processor. At 605, at least a portion of the calibration signal is communicatively coupled from the calibration signal source to at least a second device (e.g., to at least a second element of the quantum processor). Act 605 may occur in parallel with (i.e., simultaneously with) act 602 or may occur in series with (i.e., before or after) act 602. At 606, a signal that is dependent on both the calibration signal and a first determinable parameter of the at least a second device is read out via the readout system. Act 606 may occur in parallel with (i.e., simultaneously with) act 603 or may occur in series with (i.e., before or after) act 603. At 607, a value for the first determinable parameter of the at least a second device is determined based on the signal that is dependent on both the calibration signal and the first determinable parameter of the at least a second device that is read out via the readout system. Act 607 may occur in parallel with (i.e., simultaneously with) act 604 or may occur in series with (i.e., before or after) act 604. Any or all of acts 605-607 may occur in parallel with (i.e., simultaneously with) or in series with (i.e., before or after) any or all of acts 601-604.

Method 600 from FIG. 6 describes using a calibration signal source to calibrate at least two devices in a quantum processor. Some quantum processor architectures may include a plurality of devices, where each device includes at least one respective determinable parameter and with a calibration signal source communicatively coupleable to each device in the plurality of devices. In such architectures, the calibration signal source may be used to calibrate each device in the plurality of devices.

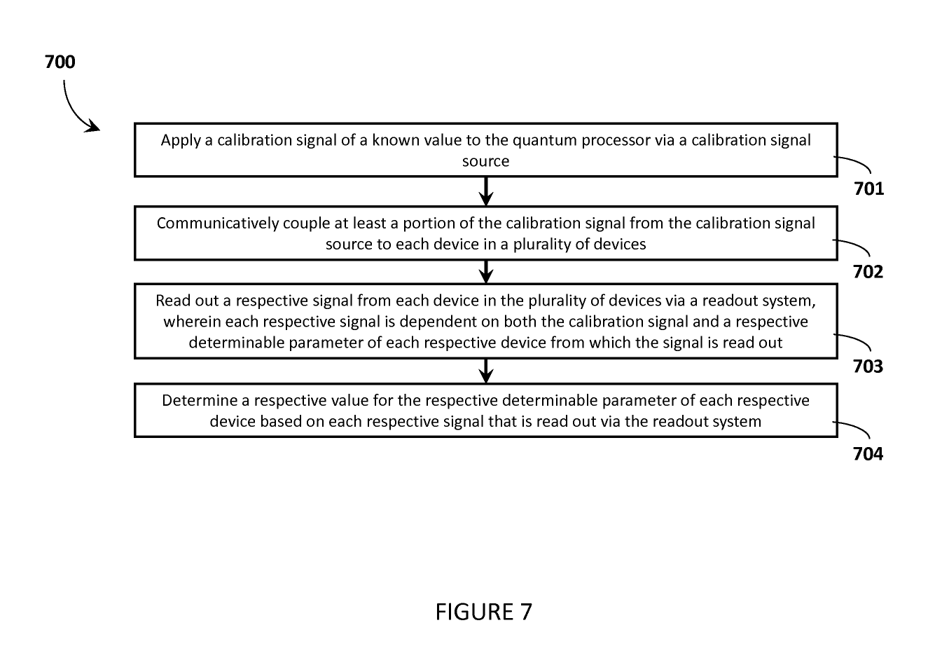

FIG. 7 is a flow-diagram showing a method 700 of using a calibration signal source to facilitate that calibration of each of a plurality of devices in a quantum processor in accordance with the present systems and methods. Method 700 includes four acts 701, 702, 703, and 704, though those of skill in the art will appreciate that in alternative embodiments certain acts may be omitted and/or additional acts may be added. Those of skill in the art will appreciate that the illustrated order of the acts is shown for exemplary purposes only and may change in alterative embodiments.

At 701, a calibration signal of a known value is applied to the quantum processor via a calibration signal source. At 702, at least a portion of the calibration signal is communicatively coupled from the calibration signal source to each device in the plurality of devices. At 703, a respective signal from each device in the plurality of devices is read out via a readout system, where each respective signal is dependent on both the calibration signal and a respective determinable parameter of each respective device from which the signal is read out. At 704, a respective value for the respective determinable parameter of each respective device is determined based on each respective signal that is read out via the readout system. For the purposes of method 700 the “plurality of devices” may comprise all devices in the quantum processor architectures or a subset of all devices in the quantum processor architecture. For example, using the scheme illustrated in FIG. 4, the “plurality of devices” may include each latching device that is directly inductively coupled to a qubit (i.e., latching devices 451 and 452), or the plurality of devices may include each qubit (i.e., qubits 401 and 402). In various quantum processor architectures, the calibration signal source may communicatively couple to each and every element in the processor architecture or to a subset of the elements in the processor architecture. Some quantum processor architectures may be better served by multiple distinct calibration signal sources (i.e., multiple independently controlled calibration signal sources) rather than a single calibration signal source.

In most quantum processor architectures, introducing a calibration signal source will carry with it associated challenges. For example, in the superconducting quantum processor architectures of FIGS. 3 and 4, a superconducting calibration line in the form of a superconducting current path may unintentionally and undesirably couple into elements of the quantum processor through stray mutual inductances. The layout of the superconducting current path and the layouts of the elements of the quantum processor should be designed to minimize such unwanted couplings through stray mutual inductances (e.g., “cross-talks”) in accordance with known practices of superconducting integrated circuit design (e.g., by controlling the spacing between devices and the geometry of devices, by implementing shielding structures, etc.). Another potential challenge is that a calibration signal source may introduce a conduit for coupling noise into the elements of the quantum processor. As previously described, the calibration signal source may only be used during calibration of the processor elements, but remains physically embedded in the quantum processor architecture while the processor is used for computations. Even with the calibration signal source deactivated, unwanted noise can couple from the calibration signal source to the elements of the quantum processor. Such noise (if present) may be at least partially reduced by electrically and/o physically decoupling the calibration signal source from its driving mechanism once calibration is completed. For example, in a superconducting quantum processor employing a superconducting current path controlled by room temperature electronics as a calibration signal source, the superconducting current path may be at least partially decoupled from the room temperature electronics (e.g., by opening resistors in the room temperature electronics circuits or otherwise disrupted current flow in the superconducting current path) after calibration procedures have been completed.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other methods of quantum computation, not necessarily the exemplary methods for quantum computation generally described above.

The various embodiments described above can be combined to provide further embodiments. All of the U.S. patents, U.S. patent application publications, U.S. patent applications, International (PCT) patent applications referred to in this specification and/or listed in the Application Data Sheet including U.S. provisional patent application Ser. No. 61/762,704 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A quantum processor comprising:
a plurality of devices, wherein at least a first device in the plurality of devices has a determinable parameter, and wherein the plurality of devices includes a plurality of qubits;
a calibration signal source that is communicatively coupleable to at least the first device in the plurality of devices, wherein the calibration signal source provides a calibration signal; and
a readout system that is communicatively coupleable to at least the first device in the plurality of devices, wherein the readout system reads out a signal that is dependent on both the calibration signal and the determinable parameter of the first device to determine a value for the determinable parameter of the first device.

2. The quantum processor of claim 1 wherein the calibration signal source is directly communicatively coupleable to the first device.

3. The quantum processor of claim 1 wherein the plurality of devices includes a second device, the second device communicatively coupleable to the first device, and wherein the calibration signal source is directly communicatively coupleable to the second device and indirectly communicatively coupleable to the first device via the second device such that the second device mediates communicative coupling between the calibration signal source and the first device.

4. The quantum processor of claim 3 wherein the plurality of devices includes at least a third device, the at least a third device communicatively coupleable to both the second device and the first device, and wherein the calibration signal source is indirectly communicatively coupleable to the first device via the second device and the at least a third device such that the second device and the at least a third device mediate communicative coupling between the calibration signal source and the first device.

5. The quantum processor of claim 1 wherein the readout system is directly communicatively coupleable to the first device.

6. The quantum processor of claim 1 wherein the plurality of devices includes a second device, the second device communicatively coupleable to the first device, and wherein the readout system is directly communicatively coupleable to the second device and indirectly communicatively coupleable to the first device via the second device such that the second device mediates communicative coupling between the readout system and the first device.

7. The quantum processor of claim 6 wherein the plurality of devices includes at least a third device, the at least a third device communicatively coupleable to both the second device and the first device, and wherein the readout system is indirectly communicatively coupleable to the first device via the second device and the at least a third device such that the second device and the at least a third device mediate communicative coupling between the readout system and the first device.

8. The quantum processor of claim 1 wherein the quantum processor includes a superconducting quantum processor, the plurality of devices includes a plurality of superconducting devices, the first device is a first superconducting device, the plurality of qubits includes a plurality of superconducting qubits, and the calibration signal source includes a superconducting calibration line formed by a superconducting current path.

9. The quantum processor of claim 8 wherein the superconducting calibration line is galvanically coupled to at least one superconducting device in the plurality of superconducting devices.

10. The quantum processor of claim 8 wherein the superconducting calibration line is inductively coupled to at least one superconducting device in the plurality of superconducting devices.

11. The quantum processor of claim 8 wherein the determinable parameter includes a persistent current of the first superconducting device.

12. The quantum processor of claim 8 wherein the plurality of superconducting devices includes at least a second superconducting device that is inductively coupleable to the first superconducting device, and wherein the determinable parameter of the first superconducting device includes a mutual inductance between the first superconducting device and the second superconducting device.

13. The quantum processor of claim 12 wherein the second superconducting device is a superconducting qubit.

14. The quantum processor of claim 1 wherein the plurality of devices includes at least a second device having a determinable parameter, the calibration signal source is communicatively coupleable to the at least a second device, and the readout system is communicatively coupleable to the at least a second device, wherein the readout system reads out a signal that is dependent on both the calibration signal and the determinable parameter of the at least a second device to determine a value for the determinable parameter of the at least a second device.

15. The quantum processor of claim 14 wherein the calibration signal source is communicatively coupleable to every device in the plurality of devices.

16. The quantum processor of claim 1 wherein the first device is a qubit.

17. The quantum processor of claim 1 wherein the plurality of devices includes at least one of: a qubit, a latching device, a coupling device, a readout device, and a programming device; and wherein the first device is selected from the group consisting of: a qubit, a latching device, a coupling device, a readout device, and a programming device.

18. A method of calibrating at least one device in a quantum processor, wherein the quantum processor comprises a plurality of devices including at least a first device having at least a first determinable parameter, a calibration signal source that is communicatively coupleable to the at least a first device, and a readout system that is communicatively coupleable to the at least a first device, the method comprising:
applying a calibration signal to the quantum processor via the calibration signal source;
communicatively coupling at least a portion of the calibration signal from the calibration signal source to the first device;
reading out a signal that is dependent on both the calibration signal and the first determinable parameter of the first device via the readout system; and
determining a value for the first determinable parameter of the first device based at least in part on the signal that is read out via the readout system.

19. The method of claim 18 wherein the calibration signal source is directly communicatively coupleable to the first device such that communicatively coupling at least a portion of the calibration signal from the calibration signal source to the first device includes communicatively coupling at least a portion of the calibration signal directly from the calibration signal source to the first device.

20. The method of claim 18 wherein the quantum processor includes at least a second device, the at least a second device communicatively coupleable to the first device, and wherein communicatively coupling at least a portion of the calibration signal from the calibration signal source to the first device includes communicatively coupling at least a portion of the calibration signal from the calibration signal source to the at least a second device and communicatively coupling at least a portion of the calibration signal from the at least a second device to the first device such that the at least a second device mediates communicative coupling between the calibration signal source and the first device.

21. The method of claim 18 wherein the readout system is directly communicatively coupleable to the first device such that reading out a signal that is dependent on both the calibration signal and the first determinable parameter of the first device via the readout system includes reading out at least a portion of the signal directly from the first device via the readout system.

22. The method of claim 18 wherein the quantum processor includes at least a second device, the at least a second device communicatively coupleable to the first device, and wherein reading out a signal that is dependent on both the calibration signal and the first determinable parameter of the first device via the readout system includes communicatively coupling at least a portion of the signal from the first device to the at least a second device and reading out at least a portion of the signal from the at least a second device via the readout system such that the at least a second device mediates communicative coupling between the first device and the readout system.

23. The method of claim 18 wherein the quantum processor includes a superconducting quantum processor, the first device includes a first superconducting device, the calibration signal source includes a superconducting calibration line formed by a superconducting current path, the quantum processor includes at least a second superconducting device, and the first determinable parameter of the first device includes a mutual inductance between the first superconducting device and the second superconducting device, and wherein:
applying a calibration signal of a known value to the quantum processor via the calibration signal source includes applying a calibration signal of a known value to the superconducting quantum processor via the superconducting calibration line;
communicatively coupling at least a portion of the calibration signal from the calibration signal source to the first device includes communicatively coupling at least a portion of the calibration signal from the superconducting calibration line to the first superconducting device;
reading out a signal that is dependent on both the calibration signal and the first determinable parameter of the first device via the readout system includes reading out a signal that is dependent on both the calibration signal and the mutual inductance between the first superconducting device and the second superconducting device via the readout system; and
determining a value for the first determinable parameter of the first device based at least in part on the signal that is read out via the readout system includes determining a value for the mutual inductance between the first superconducting device and the second superconducting device based at least in part on the signal that is read out via the readout system.

24. The method of claim 23 wherein at least one of the first superconducting device and the second superconducting device is a superconducting qubit.

25. The method of claim 18 wherein the quantum processor includes a superconducting quantum processor, the first device includes a first superconducting device, the calibration signal source includes a superconducting calibration line formed by a superconducting current path, and the first determinable parameter of the first device includes a persistent current of the first superconducting device, and wherein:
determining a value for the first determinable parameter of the first device based at least in part on the signal that is read out via the readout system includes determining a value for the persistent current of the first superconducting device based at least in part on the signal that is read out via the readout system.

26. The method of claim 18 wherein the quantum processor includes at least a second device having a first determinable parameter, the calibration signal source is communicatively coupleable to the at least a second device, and the readout system is communicatively coupleable to the at least a second device, the method further comprising:
communicatively coupling at least a portion of the calibration signal from the calibration signal source to the at least a second device;
reading out a signal that is dependent on both the calibration signal and the first determinable parameter of the at least a second device via the readout system; and
determining a value for the first determinable parameter of the at least a second device based at least in part on the signal that is dependent on both the calibration signal and the first determinable parameter of the at least a second device that is read out via the readout system.

27. The method of claim 18 wherein each device in the plurality of devices has at least one respective determinable parameter, the calibration signal source is communicatively coupleable to each device in the plurality of devices, and the readout system is communicatively coupleable to each device in the plurality of devices, the method further comprising:
communicatively coupling at least a portion of the calibration signal from the calibration signal source to each device in the plurality of devices;
reading out a respective signal from each device in the plurality of devices via the readout system, wherein each respective signal is dependent on both the calibration signal and the respective determinable parameter of the respective device from which the signal is read out; and
determining a respective value for the respective determinable parameter of each respective device based at least in part on each respective signal that is read out via the readout system.

28. The method of claim 18 wherein the at least a first device has a second determinable parameter, the method further comprising:
determining a value for the second determinable parameter of the at least a first device based at least in part on the value for the first determinable parameter of the at least a first device.
